(19) United States
(12) Patent Application Publication
(10) Pub. No.: US 2022/0234952 A1
(43) Pub. Date: Jul. 28, 2022

(54) ADMIXTURE FOR CEMENTITIOUS MIXTURES

(71) Applicants: David G. Janeway, Surrey (CA); HAZELMERE RESEARCH LTD., Surrey (CA)

(72) Inventors: David G. Janeway, Surrey (CA); Klaus H. Oehr, Surrey (CA)

(21) Appl. No.: 17/595,552

(22) PCT Filed: Jun. 5, 2020
(86) PCT No.: PCT/CA2020/050784

§ 371 Date: Nov. 18, 2021

Related U.S. Application Data
(60) Provisional application No. 62/864,805, filed on Jun. 21, 2019.

(51) Int. Cl. C04B 18/08; C04B 28/04; C04B 28/08; C04B 18/20; C04B 18/14; C04B 14/10; C04B 14/02

(52) U.S. Cl. CPC C04B 18/081; C04B 28/04; C04B 28/08; C04B 2103/304; C04B 18/146; C04B 14/106; C04B 14/022; C04B 18/20

(57) ABSTRACT

Water-based paint is used as a sacrificial agent to reduce the detrimental effect of carbon-containing fly ash on the entrainment of air in concrete. The invention provides a composition for reducing the effect of carbon contained in fly ash on air entrainment in cementitious mixtures comprising water, cement, fly ash and entrained air. The composition comprises water-based paint and one or more of pulverized or un-pulverized pozzolan, pulverized or un-pulverized cementitious solids, a superplasticizer, a defoamer, an air-entraining admixture, a water-reducing admixture, a retarding admixture, an accelerating admixture, a hydration control admixture and a rheology modifying admixture. The invention also provides a method of reducing the effect of carbon on air entrainment in carbon-containing fly ash, comprising mixing the fly ash with water-based paint.

### FIELD OF THE INVENTION

The present invention pertains to cementitious mixtures containing fly ash and carbon, and in particular to compositions and methods to improve the properties of such mixtures, including the property of air entrainment.

### BACKGROUND OF THE INVENTION

It is known in the art of cement manufacture that combustion ash, particularly coal fly ash having low carbon content, is a useful additive in the making of cementitious materials such as concrete due to the pozzolanic or cementitious properties of the combustion ash. The technical benefits to be gained from the addition of such fly ash to portland cement-based materials include reduced use of portland cement per unit volume of mortar or concrete, increased long-term strength, and improved long-term durability due to reduced water and chloride ion permeability of the mortar or concrete. Economic benefits arise from the reduction in the amount of portland cement used, the higher quality of the mortar or concrete produced and the minimization of coal fly ash sent to landfill. Environmental benefits include a reduction in the carbon footprint of producing concrete. Additional technical benefits of pozzolans, especially silica fume, in cementitious materials include reduced chloride ion penetration, and water sorptivity (capillary rise of water in cement), also known as “rising damp.”

However, the high carbon content, and more particularly the presence of activated carbon, in pozzolanic or cementitious fly ash drastically reduces its acceptance for use as a cement replacement due to its undesirable interference with air entrainment. U.S. federal and state regulations for control of mercury emissions from power plants have resulted in the contamination of much of the otherwise suitable and saleable fly ash by powdered activated carbon, which is the most popular mercury sorbent. The powdered activated carbon has a high surface area and high adsorption capacity for the air-entraining chemicals that are required for adequate freeze-thaw durability of concrete. Theoretically, above-normal levels of air-entraining chemicals can be added to the concrete to compensate for the detrimental effect of the powdered activated carbon, but since the activated carbon content of the fly ash is variable due to changing boiler power load, the air entraining chemical requirement is variable with time and ash batch. This renders it non-commercially viable due to the impractical, cumbersome, on-going necessity of air-entrainment chemical dosing modifications by the concrete producer or end-user.

The prior art discloses the use of a variety of purchased, expensive sacrificial agents designed to reduce or eliminate the detrimental effect of carbon-containing fly ash, especially activated carbon-contaminated fly ash, on deliberate air entrainment in concrete. U.S. Pat. No. 6,599,358 to Boggs describes the treatment of fly ash containing unburned carbon (column 1, line 18) with a purchased aromatic carboxylic acid, hydroxyl aromatic carboxylic acid or their salts. U.S. Pat. No. 7,976,625 to Mao et al. describes the treatment of fly ash containing carbon with a variety of purchased chemical compounds. U.S. Pat. No. 8,652,249 to Zhang et al. describes the treatment of fly ash containing unburned carbon with or without activated carbon with a purchased sacrificial amine compound or compounds. The use of silica fume in cements with or without non-activated carbon-containing fly ash to reduce chloride ion penetration is described in O. Gautefall, “Effect of condensed silica fume on the diffusion of chlorides through hardened cement paste,” American Concrete Institute. (1986) Publication SP 91-48.

The prior art has not identified sacrificial agents which are available at little or no cost to improve the economics of use of carbon-containing fly ash in blended cement manufacture used in mortars or concrete. Furthermore the prior art has not identified sacrificial agents which can also be used to at least partially mitigate chloride penetration or sorptivity (rising damp) when used with fly ash as a whole or partial substitute for silica fume.

### SUMMARY OF THE INVENTION

According to one embodiment of the invention, there is provided a composition for use in reducing the effect of carbon contained in fly ash on air entrainment in a cementitious mixture comprising water, cement, fly ash and entrained air, the composition comprising water-based paint and one or more of pulverized or un-pulverized pozzolan, pulverized or un-pulverized cementitious solids, a superplasticizer, a defoamer, an air-entraining admixture, a water-reducing admixture, a retarding admixture, an accelerating admixture, a hydration control admixture and a rheology modifying admixture.

According to a further aspect of the invention, there is provided a composition comprising carbon-containing fly ash and water-based paint.

According to a further aspect of the invention, there is provided a method of reducing the effect of carbon contained in fly ash on air-entrainment in an air-entraining cementitious mixture, in which the cementitious mixture comprises water, cement, fly ash and entrained air, the method comprising mixing the cementitious mixture with a composition as aforesaid.

According to a further aspect of the invention, there is provided a method of reducing the effect of carbon on air entrainment in carbon-containing fly ash, comprising mixing the fly ash with water-based paint.

According to a further aspect of the invention, there is provided a use of water-based paint as a sacrificial agent for reducing the effect of carbon contained in fly ash on air-entrainment in an air entraining cementitious mixture.

These and other aspects of the invention will be apparent from the following description and claims.

### DETAILED DESCRIPTION

The present inventors have determined that water-based paint, including waste water-based paint, e.g., waste latex paint, is a sacrificial agent able to reduce or eliminate the detrimental effect of carbon-containing fly ash, on the entrainment of air in concrete. Waste water-based paint is available at low cost, at no cost or more usually with an economic credit via a tipping fee (a charge avoided for disposal of waste water-based paint). This unique economic feature of waste water-based paint makes it particularly attractive as a sacrificial agent as compared to sacrificial agents disclosed in the prior art. The waste water-based paint can be used as-is or processed in a variety of ways to enhance its value in blended cements. These include: sieving to remove macroscopic solid particles, e.g., coagulated dried paint, paint roller lint, etc.; and sieving and pulverizing, especially in continuous, flooded, vibratory mills containing grinding media, to reduce paint solids particle sizes and enhance paint homogeneity.

The as-is or processed waste water-based paint sacrificial agent for mortar or concrete can be used with or without any of the following additives:
pulverized or un-pulverized pozzolan;
pulverized or un-pulverized cementitious solids;
a water reducer;
a superplasticizer;
virgin latex;
a defoamer;
a retarder;
a hydration control admixture;
a rheology modifier;
an air entrainer;
synthetic, metal or natural fibres; and
a set accelerator, for example calcium chloride.

The pozzolan may be waste silica, waste bituminous, sub-bituminous, lignite coal ash or, metakaolin, especially fly ash, natural pozzolans, and ash of plant materials not meeting ASTM requirements for the use of class F fly ash in cementitious compositions due to its high particle size and/or LOI (loss on ignition) e.g., unburned carbon and/or activated carbon (derived from flue gas reduction of mercury) content.

The cementitious material may be ground granulated blast furnace slag, waste subbituminous or lignite ash, especially fly ash natural pozzolans, and ash of plant materials not meeting class CI or class C specifications, e.g., to excessive particle size and/or carbon content (e.g., unburned carbon and/or activated carbon derived from flue gas reduction of mercury. The invention also provides a method for making the admixture. The waste paint is sieved, sieved and macerated (e.g., in a blender or blender pump), or pulverized alone or in combination with plasticizer and/or a defoamer. Pulverization of the waste paint alone or in combination with sub-components such as plasticizer or defoamer reduces the particle size of its solid components and improves its homogeneity. Pulverization can be carried out in a batch or continuous flow pulverizer containing grinding media, such as a vibratory mill. An example is an acoustic sonicator such as the apparatus described in WO 2014/134724 to Arato et al.

### EXAMPLES

### Example 1. Properties of Activated Carbon Contaminated Class C Fly Ash Mortars with and without Un-Pulverized Waste Paint, Low Dose Plasticizer and a Defoamer

TABLE 1

| Paint | None | Un-pulverized |
|---|---|---|
| Ash wt. % of binder | 40 | 40 |
| portland cement | 60 | 60 |
| wt. % of binder | | |
| Waste paint dosage | 0 | 5 |
| kg/100 kg binder | | |
| Air entraining | Micro Air | None |
| admixture | | |
| Air-entraining | 1.75 | 0 |
| admixture (Micro | | |
| Air) dosage mL/kg | | |
| binder | | |
| Defoamer | None | Foamblast |
| | | 390M |
| Defoamer dosage | 0 | 3.75 |
| g/kg binder | | |
| Plasticizer | Glenium | Glenium 3030 |
| | 3030 | |
| Plasticizer dosage | 5 | 5 |
| g/kg binder | | |
| w/b ratio | 0.478 | 0.409 |
| Slump, mm | 200 | 182 |
| Air content, % | 6.6 | 10.8 |
| Compressive | 41.3 | 44.2 |
| strength @ 28 days, | | |
| MPa | | |

### Legend in the Examples

wt.=weight.

Binder=portland cement+fly ash.

w/b ratio=ratio of water/binder by mass.

Air %=volume % of air in the mortar, as determined by ASTM C231 or equivalent.

MPa=megapascals, compressive strength determined as per ASTM C39 or equivalent.

Slump=slump in millimetres, as determined by ASTM C143 or equivalent.

Mortar contains 4 kg sand/kg cement.

Cement=portland cement.

Foamblast 390M is marketed by Emerald Performance Materials.

Micro Air and Glenium 3030 are marketed by BASF.

Waste paint dose excludes water content of the waste paint. For example, at 50% water content in the paint, the true liquid paint dose would be double the figures shown in the above table.

The no-paint mortar was unable to reach a satisfactory air content of about 10% even with three air-entraining admixture additions, unlike the un-pulverized paint containing mortar. The compressive strength of the paint containing activated carbon-contaminated class C fly ash mortar, without an air-entraining admixture, was higher than the paint-free mortar.

### Example 2. Properties of Activated Carbon Contaminated Class C Fly Ash Mortars with and without Pulverized Waste Paint, Low Dose Plasticizer and a Defoamer

TABLE 2

| Paint | None | Pulverized |
|---|---|---|
| Ash wt. % binder | 40 | 40 |
| portland cement wt. % | 60 | 60 |
| binder | | |
| Waste paint dosage | 0 | 5 |
| kg/100 kg binder | | |
| Air entraining | Micro Air | None |
| admixture | | |
| Air entrainer dosage | 1.75 | 0 |
| mL/kg binder | | |
| Defoamer | None | Foamblast 390M |
| Defoamer dosage | 0 | 3.75 |
| g/kg binder | | |
| Plasticizer | Glenium | Glenium 3030 |
| | 3030 | |
| Plasticizer dosage | 5 | 5 |
| g/kg binder | | |
| w/b ratio | 0.466 | 0.422 |
| Slump, mm | 198 | 192 |
| Air content, % | 7.8 | 9.8 |
| Compressive strength | 22.9 | 27 |
| @ 7 days, MPa | | |

The no-paint mortar was unable to reach a satisfactory air content of about 10% even with two air-entraining admixture additions unlike the pulverized paint containing mortar without any air-entraining admixture addition. The compressive strength of the paint containing class C fly ash mortar was higher than the paint-free mortar.

### Example 3. Water/Cement Ratio and Chloride Penetration of Class C Fly Ash Mortars Containing Pulverized Vs. Un-Pulverized Waste Paint, Plasticizer and a Defoamer

TABLE 3

| | Un- | | Un- | |
|---|---|---|---|---|
| Paint Type | pulverized | Pulverized | pulverized | Pulverized |
| Ash wt. % | 40 | 40 | 25 | 25 |
| binder | | | | |
| portland | 60 | 60 | 75 | 75 |
| cement wt. % | | | | |
| binder | | | | |
| Waste paint | 7 | 7 | 6 | 7 |
| dosage | | | | |
| kg/100 kg | | | | |
| binder | | | | |
| Air entraining | None | None | None | None |
| admixture | | | | |
| Defoamer | Foamblast | Foamblast | Foamblast | Foamblast |
| | 390M | 390M | 390M | 390M |
| Defoamer | 3.75 | 3.75 | 3.75 | 3.75 |
| dosage g/kg | | | | |
| binder | | | | |
| Plasticizer | Glenium | Glenium | Glenium | Glenium |
| | 3030 | 3030 | 3030 | 3030 |
| Plasticizer | 5 | 5 | 20 | 20 |
| dosage g/kg | | | | |
| binder | | | | |
| w/b ratio | 0.425 | 0.403 | 0.411 | 0.392 |
| Slump, mm | 203 | 188 | 205 | 210 |
| Air content, % | 10.3 | 10.4 | 10.2 | 9.9 |
| RCP | NA | NA | 899 | 877 |
| coulombs @ | | | | |
| 56 Days* | | | | |

*RCP = rapid chloride permeability as per ASTM C1202, the standard test method for electrical indication of concrete's ability to resist chloride ion penetration.

These data show that pulverizing sieved waste paint improves its resulting mortar workability and chloride penetration by allowing lower water/cement ratios when using activated carbon-contaminated class C fly ash.

### Example 4. Water/Cement Ratio and Chloride Penetration of Class CI Fly Ash Mortars Containing Pulverized Vs. Un-Pulverized Waste Paint, Plasticizer and a Defoamer

TABLE 4

| | Un- | |
|---|---|---|
| Paint Type | pulverized | Pulverized |
| Ash wt. % | 25 | 25 |
| binder | | |
| portland | 75 | 75 |
| cement wt. % | | |
| binder | | |
| Waste paint | 6 | 7 |
| dosage | | |
| kg/100 kg | | |
| binder | | |
| Air entraining | None | None |
| admixture | | |
| Defoamer | Foamblast | Foamblast |
| | 390M | 390M |
| Defoamer | 3.75 | 3.75 |
| dosage g/kg | | |
| binder | | |
| Plasticizer | Glenium | Glenium |
| | 3030 | 3030 |
| Plasticizer | 20 | 20 |
| dosage g/kg | | |
| binder | | |
| w/b ratio | 0.411 | 0.392 |
| Slump, mm | 210 | 210 |
| Air content, % | 9.8 | 9.8 |
| RCP | 897 | 742 |
| coulombs @ | | |
| 56 Days | | |

These data show that pulverizing sieved waste paint, improves its resulting mortar workability and chloride penetration by allowing lower water/cement ratios when using class CI fly ash.

### Example 5. Water/Cement Ratio and Chloride Penetration of Class F Fly Ash Mortars Containing Pulverized Vs. Un-Pulverized Waste Paint, Plasticizer and a Defoamer

TABLE 5

| | Un- | |
|---|---|---|
| Paint Type | pulverized | Pulverized |
| Ash wt. % | 25 | 25 |
| binder | | |
| portland | 75 | 75 |
| cement wt. % | | |
| binder | | |
| Waste paint | 6 | 7 |
| dosage | | |
| kg/100 kg | | |
| binder | | |
| Air entraining | None | None |
| admixture | | |
| Defoamer | Foamblast | Foamblast |
| | 390M | 390M |
| Defoamer | 3.75 | 3.75 |
| dosage g/kg | | |
| binder | | |
| Plasticizer | Glenium | Glenium |
| | 3030 | 3030 |
| Plasticizer | 20 | 20 |
| dosage g/kg | | |
| binder | | |
| w/b ratio | 0.411 | 0.387 |
| Slump, mm | 210 | 205 |
| Air content, % | 9.6 | 10.2 |
| RCP | 2266 | 1445 |
| coulombs @ | | |
| 56 Days | | |

These data show that pulverizing sieved waste paint, improves its resulting mortar workability and chloride penetration by allowing lower water/cement ratios when using class F fly ash.

### Example 6. Compressive Strength and Chloride Penetration of Pulverized Waste Paint Mortars Containing Pulverized/Partially Decarbonized Class F Fly Ash Vs Un-Pulverized/Non-Carbonized Class F Fly Ash

TABLE 6

| | Un- | |
|---|---|---|
| | pulverized/Non- | Pulverized/Partially |
| Ash Type | decarbonized | Decarbonized |
| Ash wt. % | 25 | 25 |
| binder | | |
| portland cement | 75 | 75 |
| wt. % binder | | |
| Waste paint | 7 | 7 |
| dosage kg/100 | | |
| kg binder | | |
| Air entraining | None | None |
| admixture | | |
| Defoamer | Foamblast 390M | Foamblast 390M |
| Defoamer | 3.75 | 3.75 |
| dosage g/kg | | |
| binder | | |
| Plasticizer | Glenium 3030 | Glenium 3030 |
| Plasticizer | 20 | 20 |
| dosage g/kg | | |
| binder | | |
| w/b ratio | 0.387 | 0.392 |
| Slump, mm | 205 | 190 |
| Air content, % | 10.2 | 10.8 |
| Compressive | 32.9 | 40.5 |
| strength @ 28 | | |
| days, MPa | | |
| RCP coulombs | 1445 | 900 |
| @ 56 Days | | |

These data show that pulverizing and partially decarbonizing class F fly ash increases the compressive strength and reduces chloride permeability of its waste latex paint containing mortars. The pulverized and partially decarbonized class F fly ash was created using the method of US 2012/0234211 A1 (see Table 2), using 5-second continuous pulverization.

### Example 7. Chloride Penetration of Pulverized and Un-Pulverized Paint Mortars Vs. Paint-Free Mortars Containing Class CI Fly Ash

TABLE 7

| Paint | None | Un-pulverized | Pulverized |
|---|---|---|---|
| Ash wt. % | 25 | 25 | 25 |
| binder | | | |
| portland cement | 75 | 75 | 75 |
| wt. % binder | | | |
| Waste paint | 0 | 6 | 7 |
| dosage kg/100 | | | |
| kg binder | | | |
| Air entraining | Not mentioned | None | None |
| admixture | | | |
| Defoamer | None | Foamblast 390M | Foamblast 390M |
| Defoamer | 0 | 3.75 | 3.75 |
| dosage g/kg | | | |
| binder | | | |
| Plasticizer | Not mentioned | Glenium 3030 | Glenium 3030 |
| Plasticizer | Not mentioned | 20 | 20 |
| dosage g/kg | | | |
| binder | | | |
| w/b ratio | 0.40 | 0.411 | 0.392 |
| Slump, mm | Not mentioned | 210 | 210 |
| Air content, % | Not mentioned | 9.8 | 9.8 |
| RCP coulombs | 2300 | 897 | 742 |
| @ 56 Days | | | |

These data show that using pulverized or un-pulverized paint reduces the chloride permeability of class CI fly ash containing mortars. The paint-free mortar data is from M. Thomas, Optimizing the use of fly ash in concrete (Portland Cement Association, 2007).

### Example 8. Paint/Class F Ash Vs. Silica Fume/Class F Ash Mortars

TABLE 8

| Paint | None | Pulverized | Pulverized |
|---|---|---|---|
| Ash wt. % | 10 | 25 | 25 |
| binder | | | |
| Ash | Un-pulverized/ | Un-pulverized/ | Pulverized/partially |
| | non-partially | non-partially | decarbonized |
| | decarbonized | decarbonized | |
| portland cement | 85 | 75 | 75 |
| wt. % binder | | | |
| Silica fume wt. | 5 | 0 | 0 |
| % binder | | | |
| Waste paint | 0 | 8 | 8 |
| dosage kg/100 | | | |
| kg binder | | | |
| w/b ratio | 0.5 | 0.387 | 0.392 |
| Mortar age | >180 | 56 | 56 |
| days | | | |
| Chloride | 69.3% | 67.3% | 79.7% |
| penetration | | | |
| reduction vs. | | | |
| portland mortar | | | |

Silica fume/ash data are derived from Gautefall, supra. These data show that waste latex paint can successfully substitute for silica fume in fly ash-containing mortars to reduce chloride penetration.

### Example 9. Paint/Class C Ash Concrete

The concrete mixture design included 255 kg/m³ of ASTM C150 Type I portland cement, 106 kg/m³ASTM C618 Class C fly ash, 792 kg/m³ concrete sand, 1078 kg/m³ stone, and 166 kg/m³ water. The fly ash was contaminated with powdered activated carbon (PAC) that was collected with the fly ash at the power plant. Recycled latex paint (RLP) was added to all concrete mixes at a loading of 18 kg/m³. MasterGlenium 3030 from BASF, ASTM C494 Type F high-range water-reducing admixture, was added to all concrete mixes at a dosage of 140 mL/100 kg of powders to produce workable concrete. A defoamer was added to the concrete to reduce the spurious air that results from the mixing of concrete with RLP addition. The defoamer was KemFoamX 5885 from Kemira Chemicals, Inc. The concrete-making materials were stored at low temperature and cold water was used to produce concrete with a temperature in the range of 11-13° C. after initial batching. The concrete was batched by adding all of the liquids to the drum-style laboratory concrete mixer followed by the stone, concrete sand, portland cement and fly ash. The mixer was turned on for 3 minutes at 20 rpm, then turned off for 3 minutes, and then turned on for an additional 2 minutes at 20 rpm. This was the initial batching cycle. After sampling, the mixer was rotated at 4 rpm for 90 minutes to simulate transit in a ready-mix concrete truck. The agitation cycle was used to check to see if the concrete air content was stable over time in the presence of the defoamer. Sampling and testing were performed at the end of the initial batching cycle and again at the end of the 90-minute agitation cycle. Testing consisted of measuring the slump of the concrete, as described in ASTM C143 and the air content with a Type B pressure meter as described in ASTM C231. Additional concrete cylinders were cast at the end of the agitation cycle. These hardened concrete specimens were cast for strength and durability testing. The specimens were cured in a moist environment for 76 days followed by 15 days in air (91 days total). The properties of the fresh concrete and the hardened concrete are shown in Tables 9.1 and 9.2, respectively.

TABLE 9.1
Fresh concrete properties

| | | | |
|---|---|---|---|
| KemFoamX 5885 dosage, | 0 | 84 | 168 |
| mL/100 kg powder | | | |
| Initial concrete slump | 210 mm | 205 mm | 210 mm |
| Initial concrete air content | 7.9% | 2.8% | 2.4% |
| 90-minute concrete slump | 185 mm | 170 mm | 165 mm |
| 90-minute concrete air content | 4.2% | 2.9% | 2.4% |

The results in Table 9.1 show that the defoamer is effective in controlling the air content of the concrete.

TABLE 9.2
Hardened concrete properties

| | | | |
|---|---|---|---|
| KemFoamX 5885 dosage, | 0 | 84 | 168 |
| mL/100 kg powder | | | |
| 91-day compressive strength | 45.6 MPa | 50.2 MPa | 47.6 MPa |
| 91-day boiled absorption | 5.9% | 5.5% | 5.9% |
| 91-day volume of permeable | 13.4% | 12.9% | 13.4% |
| voids | | | |
| 91-day bulk density after | 2410 kg/m³ | 2450 kg/m³ | 2450 kg/m³ |
| immersion | | | |
| 91-day rapid chloride | 630 | 820 | 870 |
| permeability value | coulombs | coulombs | coulombs |

The results in Table 9.2 show that the addition of the defoamer does not negatively impact the hardened properties of the concrete.

Concrete prepared without class C fly ash and without latex at 0.48 w,/b ratio for Type I portland cement is described in S. Diamond and Q. Sheng “Laboratory Investigations on Latex Modified Concrete” Final Report, Joint Highway Research Project FHWA/IN/JHRP-89/15-1 (1989). Compressive strength and rapid chloride permeability at 90 days and 3 months respectively were 37.1 MPa and 2901 respectively. This compares to the current invention compressive strength and chloride permeability, in the presence of a defoamer, at 91 days of 47.6-50.2 and 820 to 870 respectively. Concrete prepared at 17-20° C. using the current invention with the same defoamer used at 11-13° C. above, but with a different portland Type I cement, with the same fly ash at 0.46 w/b ratio achieved compressive strength and rapid chloride permeability of 44.5 and 487 respectively. These results show that the current invention concrete utilizing activated carbon contaminated fly ash and waste latex paint has compressive strength and chloride penetration properties superior to ordinary portland cement-based concrete.

The above Examples show that un-pulverized or pulverized waste latex paint can improve the properties of fly ash containing mortars and concretes, including the following:
Elimination of the need for air entraining admixture due to carbon contamination, especially activated carbon contamination, by acting as a sacrificial agent for carbon in air-entrained mortar or concrete.
Improvement of flow (slump) and water/cement ratio by acting as a plasticizer, in combination with other plasticizers, e.g., polycarboxylate such as Glenium (trademark), supplied by BASF.
Reduction in chloride penetration.
Improvement in compressive strength.

As presented in M. Uysal and V. Akyuncu, “Durability performance of concrete incorporating class F and class C fly ashes,” Construction and Building Materials, 34, (2012): 170-178, chloride/sorptivity correlations indicate that un-pulverized or pulverized waste latex paint will also reduce water sorptivity (rising damp) of fly ash containing mortars. This is shown in the following Table 10 which gives good predictions of water sorptivity for class C and class F ash-containing mortars using the following predictor equations for class C and class F fly ash containing mortars:

C sorptivity=0.2502×chloride coulombs/(1222.0+chloride coulombs)

F sorptivity=0.2196×chloride coulombs/(800.5+chloride coulombs)

TABLE 10

| | Chloride | Sorptivity | Sorptivity | % |
|---|---|---|---|---|
| | 90 day | 90 days | 90 days | Prediction |
| Ash | coulombs | Measured | Predicted | Error |
| None | 3000 | 0.178 | 0.178 | 0.1% |
| C | 1350 | 0.126 | 0.131 | 4.2% |
| C | 1080 | 0.146 | 0.117 | 19.6% |
| None | 1770 | 0.140 | 0.148 | 5.7% |
| C | 770 | 0.102 | 0.097 | 5.2% |
| C | 730 | 0.081 | 0.094 | 15.5% |
| None | 670 | 0.079 | 0.089 | 12.1% |
| C | 360 | 0.059 | 0.057 | 3.5% |
| C | 280 | 0.044 | 0.047 | 6.0% |
| | | | average error | 8.0% |
| | | | correlation | |
| | | | coefficient R | 0.96 |
| None | 3000 | 0.178 | 0.173 | 2.6% |
| F | 1280 | 0.126 | 0.135 | 7.2% |
| F | 990 | 0.151 | 0.121 | 19.6% |
| None | 1770 | 0.140 | 0.151 | 8.0% |
| F | 480 | 0.115 | 0.082 | 28.4% |
| F | 460 | 0.063 | 0.080 | 27.2% |
| None | 670 | 0.079 | 0.100 | 26.6% |
| F | 400 | 0.062 | 0.073 | 18.0% |
| F | 160 | 0.040 | 0.037 | 8.6% |
| | | | average error | 16.3% |
| | | | correlation | |
| | | | coefficient R | 0.91 |

1. A composition for use in reducing the effect of carbon contained in fly ash on air entrainment in a cementitious mixture comprising water, cement, fly ash and entrained air, the composition comprising water-based paint and one or more of pulverized or un-pulverized pozzolan, pulverized or un-pulverized cementitious solids, a superplasticizer, a defoamer, an air-entraining admixture, a water-reducing admixture, a retarding admixture, an accelerating admixture, a hydration control admixture and a rheology modifying admixture.

2. A composition according to claim 1, wherein the paint comprises waste paint.

3. A composition according to claim 1, further comprising non-waste water-based paint.

4. A composition according to claim 1, further comprising a synthetic, metallic or natural fibre.

5. A composition according to claim 1, wherein the pozzolan comprises bituminous coal fly ash.

6. A composition according to claim 1, wherein the pozzolan comprises silica fume.

7. A composition according to claim 1, wherein the pozzolan comprises metakaolin.

8. A composition according to claim 1, wherein the cementitious solids comprise lignite coal fly ash.

9. A composition according to claim 1, wherein the cementitious solids comprise class CI fly ash.

10. A composition according to claim 1, wherein the cementitious solids comprise ground granulated blast furnace slag.

11. A composition according to claim 1, wherein the cementitious solids comprise natural pozzolan.

12. A composition according to claim 1, wherein the cementitious solids comprise plant ash.

13. A composition according to claim 4, wherein the synthetic, metallic or natural fibre comprises polyolefin, cold-drawn hooked-end high-strength steel, or hemp fibres.

14. A composition according to claim 1, wherein the carbon is unburned carbon.

15. A composition according to claim 1, wherein the carbon is activated carbon.

16. A composition according to claim 15, wherein the carbon is powdered activated carbon.

17. A composition according to claim 1, wherein the paint comprises latex.

18. A composition according to claim 1, wherein the paint is one of sieved, sieved and macerated, and sieved and pulverized.

19. A composition according to claim 1, wherein the cementitious mixture comprises a mortar.

20. A composition according to claim 1, wherein the cementitious mixture comprises a concrete.

21.-26. (canceled)

27. A method of reducing the effect of carbon contained in fly ash on air-entrainment in an air-entraining cementitious mixture, in which the cementitious mixture comprises water, cement, fly ash and entrained air, the method comprising mixing the cementitious mixture with a composition according to claim 1.

28.-34. (canceled)

35. A method according to claim 27, further comprising using a homogenizer.

36. Use of water-based paint as a sacrificial agent for reducing the effect of carbon contained in fly ash on air-entrainment in an air-entraining cementitious mixture.
